(19) United States
(12) Patent Application Publication
(10) Pub. No.: US 2005/0121051 A1
(43) Pub. Date: Jun. 9, 2005

(54) Method for cleaning substrate and apparatus therefor

(75) Inventors: Shoichi Okano, Tokyo (JP); Norihisa Takahashi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Kaijo Corporation, Tokyo (JP)

(21) Appl. No.: 11/037,980

(22) Filed: Jan. 18, 2005

Related U.S. Application Data
(63) Continuation of application No. 09/957,119, filed on Sep. 20, 2001, now abandoned.

(30) Foreign Application Priority Data
Sep. 20, 2000 (JP) 2000-284864

(51) Int. Cl. B08B 3/10

(52) U.S. Cl. 134/1.3; 134/184; 134/186; 134/10; 134/111; 134/902

(57) ABSTRACT

A substrate cleaning method and an apparatus therefor capable of increasing a particle removal ratio at which particles firmly adhering to a substrate are removed therefrom and increasing a throughput. A substrate such as a wafer or the like placed in a cleaning tank filled therein with a cleaning liquid is cleaned by an ultrasonic vibration. Cleaning of the substrate is carried out in such a manner that an ultrasonic vibration is applied to the substrate from a bottom of the cleaning tank, during which application the substrate is kept at a predetermined inclination angle with respect to a direction of acoustic streaming in the cleaning liquid formed by propagation of an ultrasonic wave.

### BACKGROUND OF THE INVENTION

1. Field of the Invention

This invention relates to a method for cleaning a substrate which is adapted to permit contaminants such as abrasives, organic substances, metallic substances or the like adhering to a surface of a substrate such as a semiconductor substrate or the like to be removed therefrom by an ultrasonic vibration, as well as an apparatus therefor.

2. Prior Art

Recently, a semiconductor device has been configured to have a multilayer wiring structure to attain a high level of integration while keeping an aspect ratio unvaried, with development of a finer wiring structure. Wiring arrangement in the semiconductor device has been complicated with an increase in the number of wirings laminated, during which techniques of rendering asperities on a surface of the substrate flat have been widely used. Recent progress in manufacturing of a semiconductor device causes conventional flattening techniques such as etch back, reflow or the like to fail to accommodate to the manufacturing. Thus, flattening techniques such as chemical mechanical polishing (CMP) techniques have been predominantly utilized for this purpose.

A semiconductor substrate (hereinafter also referred to as “wafer”) which has been subjected to CMP processing is cleaned by such brush scrubbing as shown in FIGS. 9A and 9B. FIGS. 9A and 9B show brush scrubbing of the disc type, which is constructed so as to clean both surfaces of a wafer W subjected to CMP processing while rotating brushes Ba and Bb made of a PVA (polyvinyl alcohol) sponge material or the like and rotating the wafer W. Also, other brush scrubbing techniques of the roll type, pen type and the like are likewise utilized for this purpose. In addition, single wafer megasonic spray cleaning constructed as shown in FIG. 10 is proposed as further cleaning techniques. The single wafer megasonic spray cleaning is carried out by scanning a range indicated at an arrow R with a nozzle N equipped with a transducer V to jet a cleaning liquid at a high speed onto a wafer W placed on a spinner S, leading to cleaning of the wafer W.

The cleaning techniques described above are each of the single wafer cleaning type which is adapted to clean wafers one by one. Thus, in the conventional cleaning techniques, it is required to increase a throughput. Also, there have been conventionally proposed batch-type cleaning techniques which are practiced by means of an ultrasonic cleaning apparatus. The ultrasonic cleaning apparatus is constructed as shown in FIGS. 11A to 11C by way of example, wherein FIG. 11A shows a cleaning tank 1 which is filled therein with a cleaning liquid 6. The cleaning tank 1 is provided on a bottom thereof with an ultrasonic transducer 4, which functions to vibrate a vibration plate 3, so that a number of wafers W placed in the cleaning tank 1 in a manner to vertically extend may be cleaned. FIG. 11B shows a rinse tank and FIG. 11C shows a drying tank.

The CMP which has been recently commonly used as flattening techniques in manufacturing of semiconductors causes contaminants such as abrasives, organic substances, metal substances from wiring layers, and the like to highly firmly adhere to a front surface, a rear surface and an end surface of each of wafers which have been subjected to CMP processing. Hereinafter, such contaminants will be generally referred to as “particles”. Thus, brush cleaning and scrub cleaning are effective to remove the particles from the wafer, however, such cleaning techniques are deteriorated in throughput.

The ultrasonic cleaning apparatus shown in FIGS. 11A to 11C effectively contributes to an increase in throughput. Also, the apparatus is adapted to concurrently clean a number of wafers or semiconductor substrates, for example, 50 wafers. However, such an ultrasonic cleaning apparatus causes the semiconductor substrates to be vertically placed in the cleaning tank. Thus, it has a disadvantage of failing to increase a particle removal ratio at which particles firmly adhering to the substrate after the CMP processing are removed from the substrate. In order to increase the particle removal ratio, it would be considered to increase a period of time during which an ultrasonic vibration is applied to the wafer in a cleaning step. Unfortunately, this may often lead to damage to a surface of the wafer, although it permits an increase in particle removal ratio.

Still further cleaning techniques have been conventionally proposed, which are to be practiced using such an apparatus as shown in FIG. 12. The apparatus includes a cleaning tank provided on a side thereof with an ultrasonic transducer 4, to thereby apply an ultrasonic vibration from the ultrasonic transducer 4 to a front surface of a wafer W vertically placed in the cleaning tank. However, the cleaning techniques as well are deteriorated in throughput. In order to avoid the disadvantage, it is required to form the cleaning tank to have a laterally extending configuration rather than a vertically extending configuration and arrange a number of ultrasonic transducers on a side wall thereof. This renders the cleaning tank significantly large-sized. Also, the cleaning techniques cause an ultrasonic vibration generated by the ultrasonic transducer 4 to be applied to a wall of the cleaning tank opposite to the ultrasonic transducer 4, resulting in the wall of the cleaning tank being highly damaged.

### SUMMARY OF THE INVENTION

The present invention has been made in view of the foregoing disadvantage of the prior art.

It is an object of the present invention to provide a method for cleaning a substrate and an apparatus therefor which are capable of increasing a particle removal ratio at which particles firmly adhering to an object to be cleaned are removed therefrom and increasing a throughput.

The present invention is to solve the above-described problem. In accordance with one aspect of the present invention, a method for cleaning a substrate is provided. The substrate cleaning method includes the step of cleaning a substrate placed in a cleaning tank by generating an ultrasonic vibration from a bottom of the cleaning tank filled therein with a cleaning liquid, wherein the cleaning of the substrate is carried out while arranging the substrate at a predetermined inclination angle with respect to a direction of acoustic streaming in the cleaning liquid formed by propagation of an ultrasonic wave.

In the substrate cleaning method of the present invention, as described above, the substrate such as a semiconductor substrate or the like is cleaned by an ultrasonic vibration, during which the substrate is arranged so as to permit ultrasonic vibration energy to be applied to the substrate at a predetermined inclination angle with respect to a direction of acoustic streaming in the cleaning liquid generated due to propagation of an ultrasonic wave (or a direction perpendicular to the bottom of the cleaning tank), resulting in particles which firmly adhered to the substrate being efficiently removed therefrom. The term “bottom” of the cleaning tank generally means a plane of the vibration plate. It is also true of the case that a bottom plate of the cleaning tank functions as the vibration plate as well. It is a matter of course that the substrate to be cleaned is not limited to a wafer. Also, arrangement of the substrate or substrates may be carried out either in a cassette-load mode or in a cassette-less mode.

In a preferred embodiment of the present invention, in the cleaning of the substrate, the inclination angle is so set that an angle between a surface of the substrate to be cleaned and a plane of the bottom of the cleaning tank is rendered obtuse. In cleaning of the substrate in the cleaning tank, such arrangement of the substrate permits ultrasonic vibration energy to be applied to a surface of the substrate (for example, a rear surface thereof) opposite to a surface thereof to be cleaned (for example, a front surface thereof), resulting in a particle removal ratio at which particles adhering to the front surface are removed therefrom being increased. Of course, a surface of the substrate to be cleaned may be the rear surface. Cleaning of a surface of the substrate to be cleaned of course permits a surface thereof opposite to the surface to be likewise cleaned to a degree. In the present invention, an inclination angle θ which permits the front surface of the substrate (or a surface thereof to be cleaned) to upwardly face is defined as being positive and an inclination angle θ which permits the front surface of the substrate to downwardly face is defined as being negative. Thus, the term “obtuse” described above indicates the inclination angle θ is positive.

In a preferred embodiment of the present invention, the inclination angle θ is set to be within a range of between more than 0° and equal to or less than 16° (0°<θ≦16°). A change of the inclination angle θ from “positive” to “negative” causes ultrasonic vibration energy to be applied directly to the front surface of the substrate, to thereby deteriorate a particle removal ratio at which particles adhering to the front surface are removed therefrom. The inclination angle of 0° means that the substrate is vertically arranged in the cleaning tank. A change of the inclination angle from “negative” to “positive” permits ultrasonic vibration energy to be applied to the rear surface of the substrate, to thereby increase a particle removal ratio at which particles adhering to the front surface of the substrate are removed therefrom. The inclination angle θ above 16° leads to a deterioration or reduction in particle removal ratio or fails to increase it. The inclination angle is preferably set to be within a range between more than 0° and equal to or less than 10° (0°<θ≦10°).

Cleaning of the substrate may be carried out while rotating the substrate in a plane direction thereof. This permits the whole substrate to be uniformly cleaned.

In accordance with another aspect of the present invention, an apparatus for cleaning a substrate by an ultrasonic vibration is provided. The substrate cleaning apparatus includes a cleaning tank having an ultrasonic transducer arranged on a bottom thereof and constructed so as to permit a substrate which is to be cleaned to be placed therein in a manner to vertically extend. The bottom of the cleaning tank is inclined so that an inclination angle between a direction of acoustic streaming in a cleaning liquid formed due to propagation of an ultrasonic wave generated from the bottom of the cleaning tank and a surface of the substrate to be cleaned may be set to be within a range of 0°<θ≦16°.

In the substrate cleaning apparatus of the present invention, as described above, the bottom of the cleaning tank is arranged in an inclined manner. Such arrangement of the bottom, when the substrate is placed in the cleaning tank so as to extend in a vertical direction, permits ultrasonic vibration energy to be applied at a predetermined inclination angle to the substrate, resulting in particles which adhered to the substrate being efficiently removed therefrom. The inclination angle θ within a range of 0°<θ≦16° indicates an angle between the substrate vertically placed in the cleaning tank and a direction of acoustic streaming in the cleaning liquid from a plane of the inclined bottom of the cleaning tank. Also, the substrate is vertically placed in the cleaning tank as described above. This permits the substrate to be located at a predetermined position without requiring any cassette for carrying the substrate thereon, so that the cleaning operation may be increased in efficiency. Of course, the substrate may be arranged in a cassette-load mode. Also, the substrate is vertically placed in the cleaning tank, therefore, the cleaning is preferably carried out while rotating the substrate. Further, the bottom of the cleaning tank is provided thereon with the vibration plate by way of example. Alternatively, the present invention may be constructed so that the bottom plate of the cleaning tank functions as the vibration plate as well.

In a preferred embodiment of the present invention, the bottom of the cleaning tank is constituted by two members inclinedly arranged. Such construction permits both surfaces of the substrate to be efficiently cleaned in a single cleaning tank. For example, when the bottom of the cleaning tank is inclined in only one direction, only one surface of the substrate is predominantly cleaned. Thus, efficient cleaning of both of the front and rear surfaces of the substrate requires two cleaning tanks, each for cleaning a respective one of these surfaces. On the contrary, in the embodiment, the bottom of the cleaning tank is constituted by the two members which are inclined in two directions different from each other. Such arrangement permits acoustic streaming in the cleaning liquid generated due to an ultrasonic vibration to progress in different directions, so that vibration energy may be efficiently applied to both surfaces of the substrate. This results in cleaning of both surfaces of the substrate being attained in a single cleaning tank. For example, the substrate cleaning method using the thus-constructed cleaning tank may be practiced in a manner to alternately vibrate vibration plates mounted on the members of the bottom of the cleaning tank inclined at different angles, so that the front and rear surfaces of the substrate may be alternately cleaned.

Moreover, in the present invention, a first cleaning tank in which the vibration plate is provided so as to permit acoustic streaming in the cleaning liquid to proceed toward a center of the cleaning tank and a second cleaning tank in which it is arranged so as to permit acoustic streaming in the cleaning liquid to proceed toward a side wall of the cleaning tank may be arranged in juxtaposition. In such arrangement, a number of substrates or wafers are concurrently placed in the first cleaning tank and then vertically placed in the second cleaning tank. This results in both surfaces of the wafers being effectively cleaned. Cleaning of the substrates in the cleaning tanks having the bottoms inclined at different angles, respectively, leads to an increase in throughput.

### BRIEF DESCRIPTION OF THE DRAWINGS

FIG. 1 is a schematic sectional view showing a substrate cleaning apparatus for illustrating an embodiment of a substrate cleaning method according to the present intention;

FIG. 2 is a graphical representation showing a particle removal ratio attained by the embodiment of FIG. 1;

FIGS. 3A, 3B and 3C are schematic views showing a cleaning step in the embodiment of FIG. 1;

FIG. 4 is a schematic sectional view showing an embodiment of a substrate cleaning apparatus according to the present invention;

FIG. 5 is a graphical representation showing a particle removal ratio obtained by the embodiment of FIG. 4;

FIGS. 6A to 6D are schematic views showing a cleaning step carried out in the embodiment of FIG. 4;

FIG. 7 is a schematic sectional view showing another embodiment of a substrate cleaning apparatus according to the present invention;

FIG. 8A, 8B and 8C are schematic views showing a cleaning step carried out in the embodiment of FIG. 7;

FIG. 9A and 9B are schematic views each showing a conventional substrate cleaning method carried out by disc-type brush scrubbing or the like;

FIG. 10 is a schematic view showing another conventional substrate cleaning method;

FIGS. 11A, 11B and 11C are schematic views showing a cleaning step in a conventional substrate cleaning method; and

FIG. 12 is a schematic sectional view showing a further conventional substrate cleaning method.

### DESCRIPTION OF THE PREFERRED EMBODIMENTS

Now, embodiments of a substrate cleaning method and an apparatus therefor according to the present invention will be described with reference to accompanying drawings.

### First Embodiment

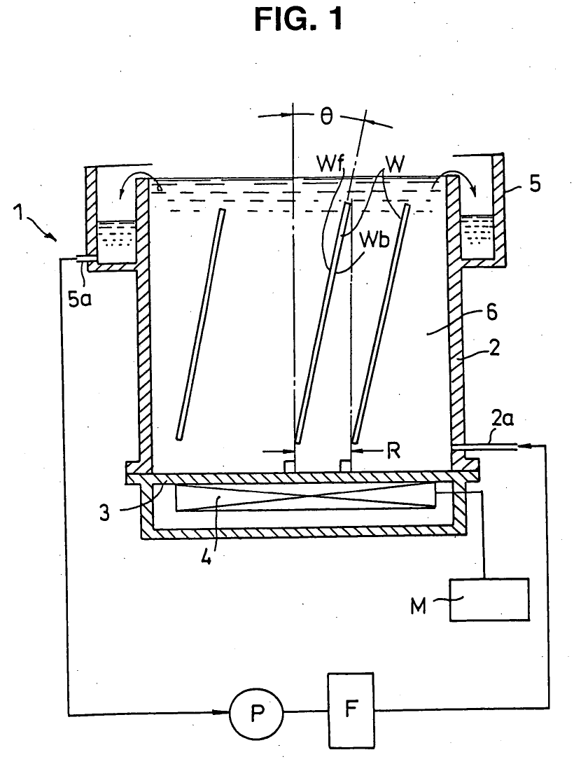

Now, an embodiment of a substrate cleaning method according to the present invention will be described with reference to FIGS. 1 to 3C. First of all, a substrate cleaning apparatus used for practicing a substrate cleaning method of the illustrated embodiment will be described with reference to FIG. 1, which is a schematic sectional view of the apparatus. The substrate cleaning apparatus shown in FIG. 1 includes a cleaning tank 1 including a tank body 2. The tank body 2 of the cleaning tank 1 has a vibration plate 3 arranged at a bottom thereof. The vibration plate 3 is provided on a rear surface thereof with an ultrasonic transducer 4. The cleaning tank 2 is provided on an upper portion thereof with an overflow receiver 5. The tank body 2 is provided at a lower portion thereof with a cleaning liquid feed port 2a. The overflow receiver 5 is provided at a lower portion thereof with a cleaning liquid discharge port 5a. The cleaning tank 1 is filled therein with a cleaning liquid 6 such as pure water, alcohol chemical cleaning liquid or the like depending on objects to be cleaned and properties of particles. The ultrasonic transducer 4 is constructed so as to permit an ultrasonic wave to be oscillated from an ultrasonic oscillator M, to thereby apply vibration to the vibration plate 3, resulting in acoustic streaming in the cleaning liquid 6 being generated. The acoustic streaming is generated so as to proceed in a vertical direction with respect to the vibration plate 3.

In the substrate cleaning apparatus of FIG. 1 constructed as described above, wafers (substrates such as wafers or the like) W are each located in the cleaning tank 1 in such a manner that a front surface Wf thereof to be cleaned in a cleaning operation upwardly faces. Also, the wafers W are each arranged so as to be inclined with respect to a plane vertical to a flat surface of the vibration plate 3. An inclination angle θ of the wafers W is within a range of between more than 0° and equal to or less than 16° (0°<θ≦16°). Alternatively, it is a matter of course that rear surfaces Wb of the wafers W may be cleaned. The cleaning tank 1 is filled therein with pure water (deionized water, hereinafter referred to as “DIW”) acting as the cleaning liquid 6. The cleaning liquid 6 is raised to an opening of the cleaning tank 1 by an ultrasonic vibration. Then, the cleaning liquid 6 overflowing the cleaning tank 1 flows into the overflow receiver 5. The cleaning liquid 6 flowing into the overflow receiver 5 is then fed from the cleaning liquid discharge port 5a via the cleaning liquid feed port 2a into the cleaning tank 1 while being pumped through a filter F by a circulating pump P. Thus, the cleaning liquid 6 is repeatedly circulated through the substrate cleaning apparatus.

The wafers W are arranged in the cleaning tank using any suitable mode such as a cassette-load mode or a cassette-less mode. The wafers W are each arranged in such a manner that the front surface Wf thereof upwardly faces and the rear surface Wb thereof downwardly faces, as described above. In any event, polishing of the wafer W by CMP techniques causes contaminants to firmly adhere to the front surface of the wafer, the rear surface thereof and a side surface thereof. The above-described arrangement of the wafer W in the cleaning tank permits the contaminants which firmly adhered to the wafer W to be effectively removed from the wafer W.

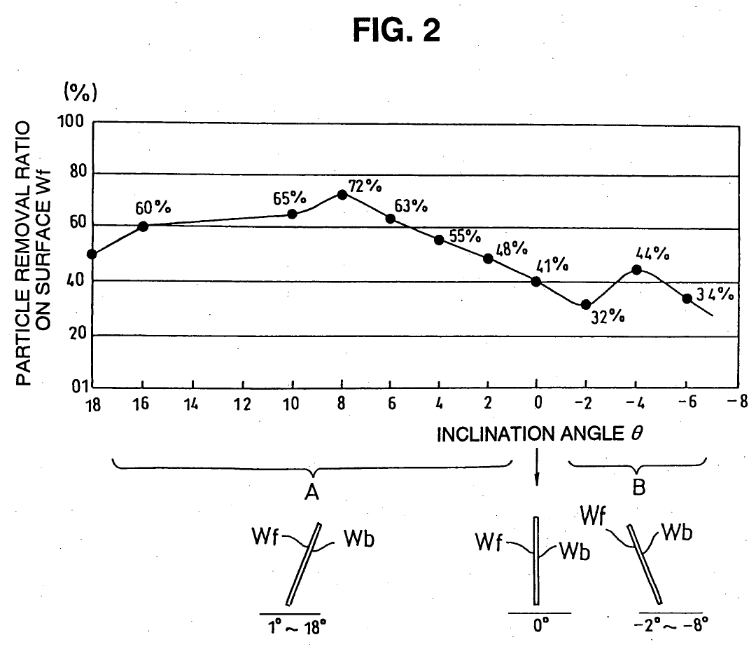

In order to confirm an effect of the illustrated embodiment, a cleaning test was carried out on each of wafers W polished by CMP techniques. The cleaning test was carried out under conditions shown in the following Table 1. The wafers W were each 200 mm in diameter and formed on a surface thereof with a thermal oxide film (SiO₂) having a thickness of 5000 Å. Al₂O₃ was added to a solvent to prepare a blend and then the blend was applied as contaminants (particles) to one surface of each of the wafers W. After drying of the wafers W, they were placed in the cleaning tank 1 of 45 l in volume and an ultrasonic cleaning test was carried out on the wafers W. DIW was filled in the cleaning tank 1 so as to act as the cleaning liquid 6. Cleaning time was set to be two minutes. The cleaning liquid 6 was circulated at a rate of 20 l/min. Rinsing was carried out for five minutes while circulating DIW at a rate of 25 /min. In the cleaning test, four specimens were prepared and cleaned, resulting in an average removal ratio thereof being measured. FIG. 2 shows the measured average removal ratio in the form of a graphical representation.

TABLE 1

| | | |
|---|---|---|
| Specimen | wafer | 200 mm in diameter, |
| | | SiO₂: 5000 Å |
| | particles | Al₂O₃ |
| | particle size | 0.2 μm in diameter |
| Cleaning tank | cleaning liquid | DIW (water temperature: |
| | | 24° C.) |
| | energy density | 4.5 W/cm² |
| | cleaning time | 2 min |
| | volume of cleaning tank | 45 l |
| | unit flow rate of | 20 l/min |
| | cleaning liquid | |
| Rinsing tank | rinsing liquid | DIW (water temperature: |
| | | 24° C.) |
| | rinsing time | 5 min |
| | unit flow rate of | 25 l/min |
| | rinsing liquid | |

FIG. 2 shows results of the cleaning test or a removal ratio at which particles adhering to the wafers W are removed therefrom. In FIG. 2, an axis of abscissae indicates the inclination angle θ and an axis of ordinates indicates the removal ratio (%). A numerical value of the removal ratio in FIG. 2 indicates an average removal ratio. The inclination angle θ of the wafer W is defined to be an angle of the wafer W with respect to a plane vertical to a flat surface of the vibration plate 3. Also, an inclination angle θ of the wafer W obtained when the front surface Wf of the wafer W is kept upwardly facing is defined to be positive and an inclination angle θ of the wafer W obtained when the front surface Wf of the wafer W is kept downwardly facing is defined to be negative. As will be noted from the results shown in FIG. 2, the removal ratio is increased in a region A in which the inclination angle θ is within a range of between 1° and 16° and decreased in a region B in which the inclination angle θ is within a range of between −2° and −8°. Thus, it was found that arrangement of the wafer W in the cleaning tank while keeping the front surface Wf of the wafer W facing upwardly and keeping the inclination angle θ within a range of 0°<θ≦16° permits particles adhering to the wafer W to be efficiently removed. The inclination angle θ is preferably within a range of 0°<θ≦10°.

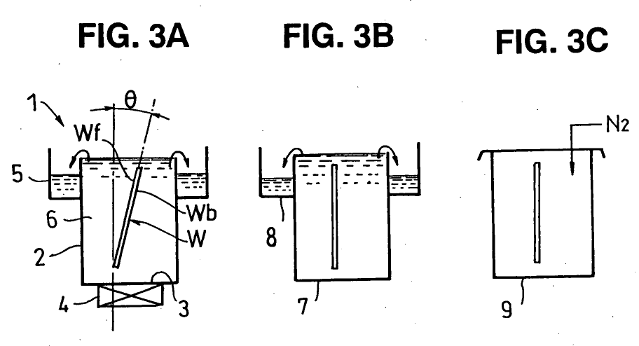

Now, the substrate cleaning method of the present invention will be described more in detail with reference to FIGS. 3A to 3C. A cleaning tank shown in FIG. 3A is constructed in the same manner as that shown in FIG. 1. The substrate cleaning method of the illustrated embodiment will be described in order of steps thereof.

First, a step of ultrasonic cleaning of the wafers W is carried out. In the cleaning step, the wafers W are located in the cleaning tank 1 of FIG. 3A filled therein with DIW, so that the ultrasonic cleaning is carried out. The wafers W are arranged at the predetermined inclination angle θ so that the front surfaces Wf thereof upwardly face with respect to a plane of the vibration plate 3 in a vertical direction (or in a direction of acoustic streaming). The inclination angle θ is set to be within a range of 0°<θ≦16°. The ultrasonic cleaning step permits the rear surfaces, of the wafers W as well as the front surfaces thereof to be significantly cleaned, although the rear surfaces are reduced in particle removal ratio as compared with the front surfaces.

Alternatively, it is a matter of course that the ultrasonic cleaning step may be carried out at the predetermined inclination angle θ while keeping the rear surfaces Wb of the wafers W facing upwardly in the same cleaning tank after cleaning of the front surfaces Wf thereof. The cleaning step may be carried out using either a plurality of cleaning tanks or a single cleaning tank. When a single cleaning tank is used, the wafers W are arranged in a cleaning tank in a cassette-load mode. Then, the front surfaces of the wafers W may be subjected to cleaning and then the cassette may be operated to vary the inclination angle θ of the wafers W, followed by cleaning of the rear surfaces of the wafers W.

After the step of ultrasonic cleaning the wafer W is completed, the operation is advanced to a rinsing step. The rinsing step takes place in a rinsing tank 7 of FIG. 3B filled with DIW. Rinsing time is set to be 5 minutes. The rinsing tank 7 is provided on an upper portion thereof with an overflow receiver 8, so that DIW may be circulated via a filter (not shown).

Subsequent to the rinsing step, the operation progresses to a drying step. In the drying step, as shown in FIG. 3C, the wafers W are arranged in a drying tank 9 and then nitrogen gas at a high temperature is circulated in the tank. Alternatively, the wafers W are subjected to drying under a reduced pressure or in a vacuum atmosphere.

In the illustrated embodiment, as will be noted from the experimental results shown in FIG. 2, the substrate cleaning is carried out in such a manner that acoustic streaming in the cleaning liquid runs into the rear surfaces Wb of the wafers W, to thereby mainly remove the particles adhering to the front surfaces Wf therefrom. The illustrated embodiment permits the rear surfaces Wb of the wafers W reduced in removal ratio as compared with the front surfaces Wf to be efficiently cleaned. Any conventional apparatus may be used for the illustrated embodiment.

More particularly, in the illustrated embodiment, the substrate cleaning is carried out in such a manner that the inclination angle θ of the wafers with respect to the vertical plane of the vibration plate is defined so as to permit an angle between the rear surfaces of the wafers and the vibration plate to be acute or an angle between the front surfaces of the wafers and the vibration plate to be obtuse, to thereby increase a particle removal ratio at which the particles adhering to the surfaces of the wafers which face upward are removed therefrom.

When a plurality of the wafers W are located in the cleaning tank 1, the wafers W, as shown in FIG. 1, may be preferably arranged in a manner to be spaced from each other at predetermined intervals R so that vibration energy generated from the vibration plate 3 may be applied to the whole rear surface Wb of each of the wafers W.

It is a matter of course that arrangement of the wafers W which permits the inclination angle θ of the wafers to be adjusted when the wafers W are received in a cassette leads to an improvement in workability, resulting in an increase in throughput. Also, the illustrated embodiment may be constructed in such a manner that the wafers are each rotated in a plane direction thereof while being subjected to ultrasonic cleaning in the cleaning tank 1. Such construction permits particles adhering to each of the wafers to be uniformly removed therefrom, to thereby lead to an improvement in particle removal ratio and a reduction in cleaning time, resulting in a further increase in throughput.

### Second Embodiment

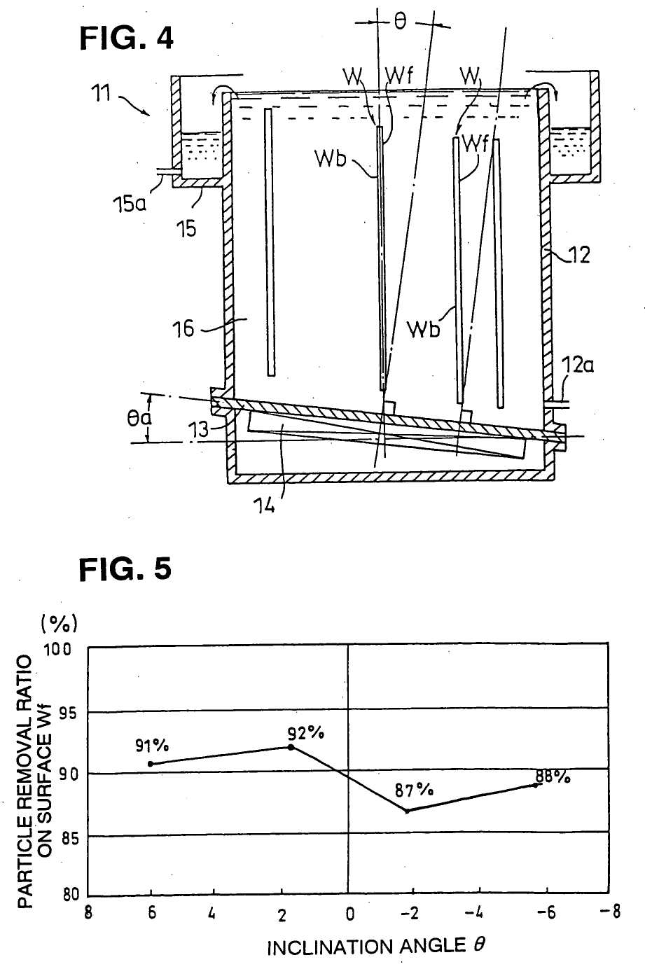

Referring now to FIGS. 4 to 6D, a second embodiment of a substrate cleaning method and an apparatus therefor according to the present invention will be described hereinafter. In the first embodiment described above, the substrate cleaning is carried out in such a manner that the inclination angle θ of the wafers with respect to the vertical plane of the vibration plate is provided, to thereby improve a particle removal ratio at which particles adhering to the surfaces of the wafers which face upward are removed therefrom. A cleaning apparatus of FIG. 4 is constructed so as to have substantially the same advantage as that of the above-described first embodiment by inclining a vibration plate 13.

The substrate cleaning apparatus of the second embodiment shown in FIG. 4 includes a cleaning tank 11 including a tank body 12. The tank body 12 of the cleaning tank 11 has the vibration plate 13 arranged at a bottom thereof in an inclined manner. The vibration plate 13 is provided on a rear surface thereof with an ultrasonic transducer 14. Acoustic streaming in a cleaning liquid 16 generated due to an ultrasonic wave is propagated in a vertical direction with respect to a plane of the vibration plate 13. The wafers W to be cleaned are arranged in the cleaning tank 11 so as to vertically extend. The tank body 12 of the cleaning tank 11 is provided on an upper portion thereof with an overflow receiver 15. The overflow receiver 15 is provided at a lower portion thereof with a cleaning liquid discharge port 15a. Also, the tank body 12 is provided at a lower portion thereof with a cleaning liquid feed port 12a. The cleaning liquid 16 such as DIW or the like is recycled via a circulating path (not shown).

In the illustrated embodiment, the wafers W are placed in the cleaning tank 11 filled with the cleaning liquid 16 while being kept vertical. The wafers W are each arranged so as to be inclined with respect to a plane vertical to a plane of the vibration plate 13. An inclination angle θ of the wafers W is set to be within a range of between more than 0° and equal to or less than 16° (0°<θ≦16°), as in the first embodiment described above. The inclination angle θ is preferably within a range of between more than 0° and 10° or less (0°<θ≦10°). More particularly, an angle θa between the vibration plate 13 and a horizontal plane is rendered equal to the inclination angle θ. Thus, the angle θa of the vibration plate 13 is set to be within a range of 0°<θ≦16° and preferably within a range of 0°<θ≦10°. Thus, arrangement of the vibration plate 13 in such an inclined manner permits an increase in particle removal ratio at which particles adhering to a surface of each of the wafers W on a side thereof which renders an angle between the wafer W and the vibration plate obtuse are removed therefrom.

FIG. 5 shows results of a cleaning test carried out in the illustrated embodiment, in which a particle removal ratio is indicated as a function of the inclination angle θ. In FIG. 5, an axis of abscissae indicates the inclination angle θ and an axis of ordinates indicates the removal ratio (%). A positive inclination angle θ indicates a particle removal ratio of 90% or more, and a negative inclination angle θ indicates a reduction in particle removal ratio. The cleaning test in the illustrated embodiment indicates a tendency similar to that in the first embodiment described above. In this cleaning test, Al₂O₃ was added to a solvent to prepare a blend and then the blend was applied as the particles to the wafers W. The cleaning tank was 13 l in volume. A flow rate of the cleaning liquid overflowing the cleaning tank was set to be 5.5 l/min. Megasonic (MS) energy density was set to be 4.5 W/cm².

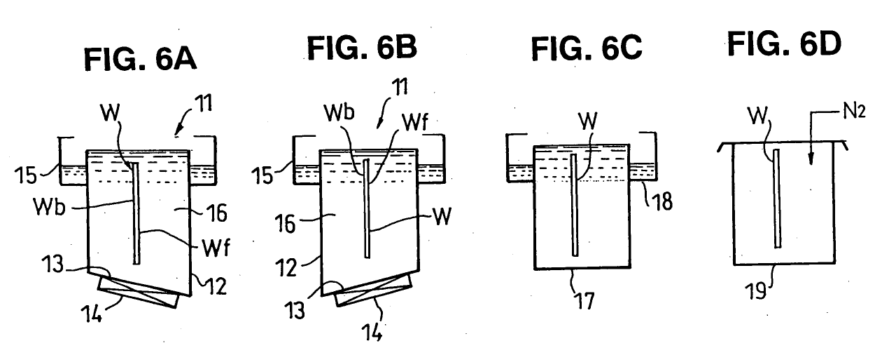

Now, the substrate cleaning method of the illustrated embodiment will be described with reference to FIGS. 6A to 6D. A cleaning tank shown in each of FIGS. 6A to 6B is constructed in the same manner as that shown in FIG. 4. The substrate cleaning method of the illustrated embodiment will be described in order of cleaning steps.

First, a first step of ultrasonic cleaning of the wafers W is carried out. In this cleaning step, wafers W are located in a cleaning tank 11 of FIG. 6A filled with DIW, so that the ultrasonic cleaning is carried out. The wafers W are arranged in the cleaning tank 11 so as to vertically extend. Each of the wafers W is arranged so that a rear surface Wb of the wafer W faces a side on which an angle between the wafer W and a vibration plate 13 is acute and a front surface Wf of the wafer W faces a side on which an angle between the wafer W and the vibration plate 13 is obtuse. An angle between a vertical plane of the vibration plate 13 (or a direction of acoustic streaming in the cleaning liquid 16) and the wafer W is defined to be an inclination angle θ. This step permits acoustic streaming in the cleaning liquid to strike against the rear surfaces of the wafers W, to thereby predominantly remove particles, adhering to the front surfaces of the wafers W therefrom.

After the step of cleaning the front surfaces of the wafers W is completed, the operation proceeds to a second step of cleaning the rear surfaces of the wafers. A cleaning tank 11 of FIG. 6B is constructed so as to be different from that of FIG. 6A in that a vibration plate 14 is inclined in a direction which is substantially laterally symmetric with respect to that of the cleaning tank 11 of FIG. 6A. The wafers W placed in the cleaning tank 11 of FIG. 6A are charged in the cleaning tank 11 of the FIG. 6B for further ultrasonic cleaning while being moved in parallel. Cleaning time may be set to be less than that in the first cleaning step. In each of the cleaning steps, the cleaning liquid 16 overflowing the cleaning tank 11 is repeatedly circulated in substantially the same manner as that described above with reference to FIG. 1, although this is not shown. DIW is charged in the cleaning tank 11 so as to act as the cleaning liquid 16.

After the step of ultrasonic cleaning of both surfaces of the wafers W is completed, the operation proceeds to a rinsing step. The rinsing step takes place in a rinsing tank 17 of FIG. 6C filled with DIW. The rinsing tank 17 is provided on an upper portion thereof with an overflow receiver 18, so that DIW may be circulated via a filter as in the cleaning tank, although this is not shown. Rinsing time is set to be 5 minutes.

Subsequent to the rinsing step, the operation proceeds to a drying step. In the drying step, as shown in FIG. 6D, the wafers W are arranged in a drying tank 19 and then nitrogen gas at a high temperature is circulated in the tank. Alternatively, the wafers W are subjected to drying under a reduced pressure or in a vacuum atmosphere.

### Third Embodiment

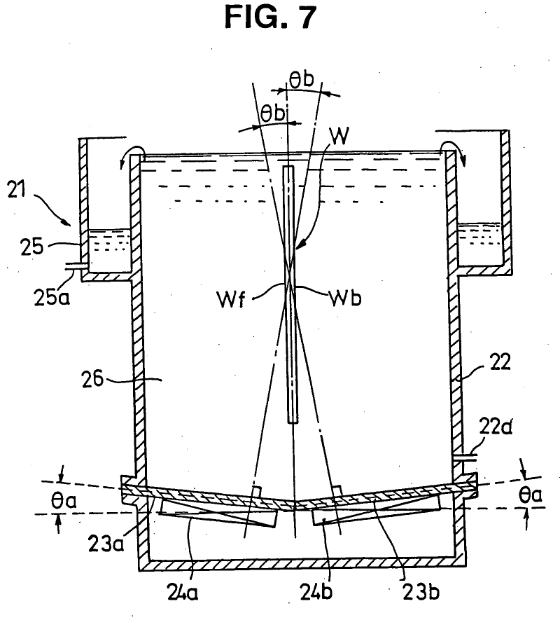

A further embodiment or third embodiment of a substrate cleaning method and an apparatus therefor according to the present invention will be described with reference to FIG. 7, which is a schematic sectional view of a substrate cleaning apparatus of the illustrated embodiment. A substrate cleaning apparatus shown in FIG. 7 includes a cleaning tank 21 including a tank body 22. The tank body 22 of the cleaning tank 21 has two vibration plates 23a and 23b arranged at a bottom thereof so as to be downwardly inclined toward a center of the bottom. The vibration plates 23a and 23b are provided on rear surfaces thereof with ultrasonic transducers 24a and 24b, respectively. Acoustic streaming in the cleaning liquid generated due to an ultrasonic vibration of the vibration plates 23a and 23b is permitted to strike at a predetermined incident angle against both surfaces of a wafer W (front and rear surfaces Wf and Wb thereof) arranged at a center of the cleaning tank 21 so as to vertically extend. An angle θb between the wafer W arranged in the cleaning tank 21 so as to vertically extend and a direction of the acoustic streaming is set to be within a range between more than 0° and 16° or less (0°<θb≦16°). The angle θb is preferably within a range of between more than 0° and 10° or less (0°<θb≦10°). The angle θb corresponds to such an inclination angle θ as described above and the vibration plates 23a and 23b are each arranged at an angle θa, which is equal to the angle θb. Thus, the angle θa corresponds to the inclination angle θ.

In the ultrasonic cleaning, the ultrasonic transducers 24a and 24b may be concurrently driven. Alternatively, the ultrasonic transducers 24a and 24b may be alternately driven. A cleaning liquid 26 such as DIW or the like is recycled as in each of the above-described first and second embodiments.

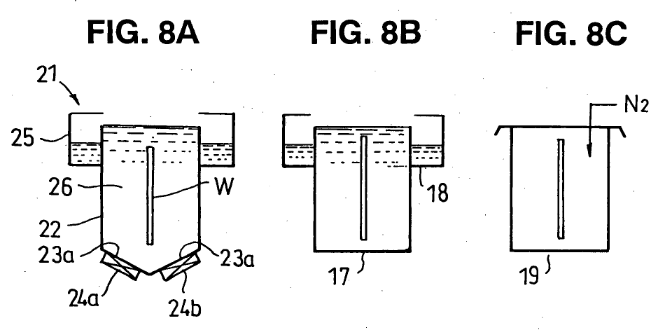

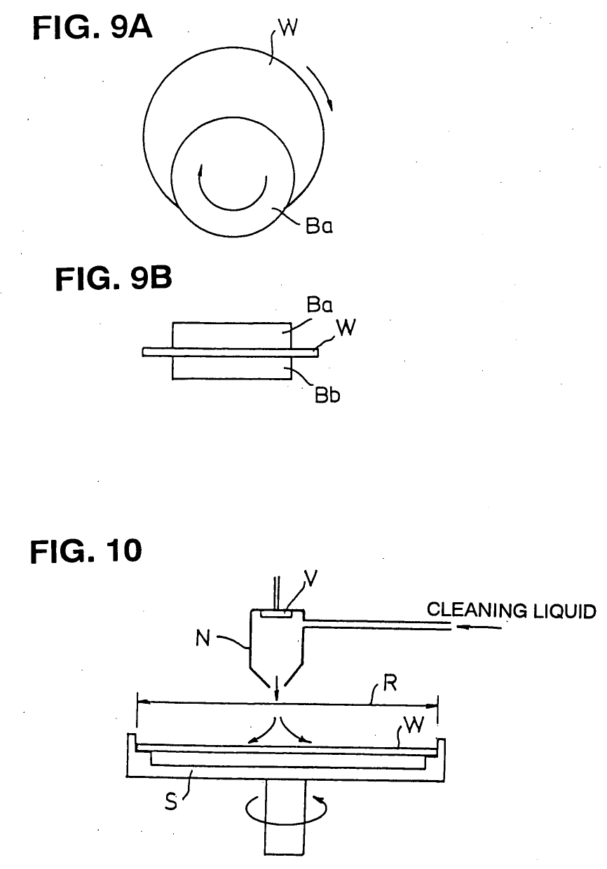

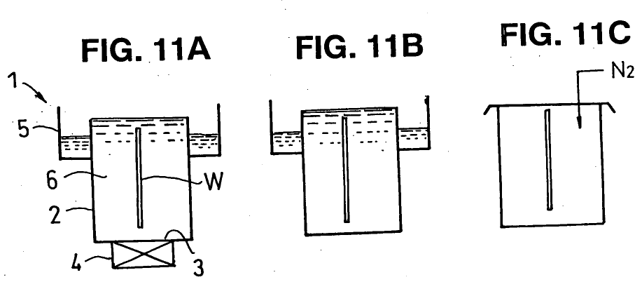

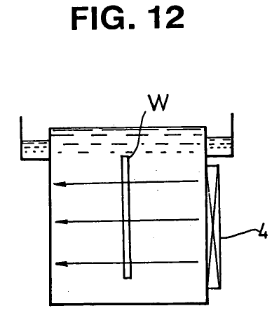

A cleaning method using the cleaning tank constructed as described above, as shown in FIGS. 8A to 8C, is practiced by placing each of the wafers W in the cleaning tank 21, a rinsing tank 17 and a drying tank 19 in order, to thereby clean it. This cleaning method is of a single wafer processing type. This fails to exhibit an increased throughput. Concurrent ultrasonic cleaning of numerous wafers may be attained by constructing the cleaning tank in such a manner that the vibration plates, are arranged so as to permit an intermediate portion of the bottom of the cleaning tank to be raised and a peripheral portion thereof to be lowered. Then, the transducer is arranged on a rear surface of each of the vibration plates, so that acoustic streaming in the cleaning liquid may be directed outwardly from each of the vibration plates. Also, arrangement of the thus-constructed cleaning tank in combination with the cleaning tank of FIG. 7 permits a number of wafers to be charged in the cleaning tanks in turn, to thereby clean one surfaces of the wafers in one of the cleaning tanks and the other surfaces thereof in the other cleaning tank, resulting in throughput being increased.

When the wafers are arranged in the cleaning tank so as to vertically extend, the second and third embodiments described above may be constructed in such a manner that the wafers are each rotated in a plane direction thereof while being subjected to ultrasonic cleaning in the cleaning tank. Such construction permits particles adhering to each of the wafers to be uniformly removed therefrom. It is a matter of course that although the above description has been made in connection with the case that wafers are used as substrates to be cleaned, the present invention is not limited to such wafers.

Also, although the above description has been made in connection with the case that a front surface of a wafer is cleaned, a rear surface thereof may be cleaned.

As can be seen from the foregoing, the present invention provides a substrate cleaning method which permits an increase in particle removal ratio by a cleaning operation using any conventional facilities even if particles firmly adhere to wafers or the like which have been subjected to a CMP process.

Also, the present invention permits a large number of objects to be concurrently cleaned and leads to an increase in particle removal ratio, to thereby increase throughput. Also, rotating of the wafers while subjecting them to cleaning leads to a reduction in cleaning time, resulting in a further increase in throughput.

Further, the present invention permits a substrate such as a wafer or the like to be cleaned without inclining the substrate by inclining the vibration plate arranged at the bottom of the cleaning tank, to thereby eliminate additional steps such as a substrate inclining step and the like and increase a particle removal ratio, resulting in an increase in throughput. In addition, the present invention leads to down-sizing of the substrate cleaning apparatus.

1. A method for cleaning a substrate by an ultrasonic vibration, comprising the step of:
cleaning a substrate placed in a cleaning tank by generating an ultrasonic vibration from a bottom of said cleaning tank filled therein with a cleaning liquid;
said cleaning of said substrate being carried out while arranging said substrate at a predetermined inclination angle with respect to a direction of acoustic streaming in said cleaning liquid formed by propagation of an ultrasonic wave.

2. A method for cleaning a substrate as defined in claim 1, wherein in said cleaning of said substrate, said inclination angle is so set that an angle between a surface of said substrate to be cleaned and a plane of the bottom of said cleaning tank is rendered obtuse.

3. A method for cleaning a substrate as defined in claim 1, wherein when said inclination angle is represented by θ, θ is set to be within a range between more than θ and equal to or less than 16° (0°<θ≦16°).

4. A method for cleaning a substrate as defined in claim 2, wherein when said inclination angle is represented by θ, θ is set to be within a range between more than 0° and equal to or less than 16° (0°<θ≦16°).

5. A method for cleaning a substrate as defined in claim 1, wherein said cleaning of said substrate is carried out while rotating said substrate in a plane direction thereof.

6. A method for cleaning a substrate as defined in claim 2, wherein said cleaning of said substrate is carried out while rotating said substrate in a plane direction thereof.

7. A method for cleaning a substrate as defined in claim 3, wherein said cleaning of said substrate is carried out while rotating said substrate in a plane direction thereof.

8. A method for cleaning a substrate as defined in claim 4, wherein said cleaning of said substrate is carried out while rotating said substrate in a plane direction thereof.

9. An apparatus for cleaning a substrate by an ultrasonic vibration, comprising:
a cleaning tank having an ultrasonic transducer arranged on a bottom thereof and constructed so as to permit a substrate which is to be cleaned to be placed therein in a manner to vertically extend;
said bottom of said cleaning tank being inclined so that an inclination angle θ between a direction of acoustic streaming in a cleaning liquid formed due to propagation of an ultrasonic wave generated from said bottom of said cleaning tank and a surface of said substrate to be cleaned may be set to be within a range of 0°<θ≦16°.

10. An apparatus for cleaning a substrate as defined in claim 9, wherein said bottom of said cleaning tank is constituted by two members inclinedly arranged.
